(19) United States
(12) Patent Application Publication
(10) Pub. No.: US 2026/0153182 A1
(43) Pub. Date: Jun. 4, 2026

(54) SEALANT INJECTION UNIT FOR DUCT SEALING SYSTEM

(71) Applicant: Aeroseal LLC, Miamisburg, OH (US)

(72) Inventors: Kenneth Herman Bedel, Vandalia, OH (US); Zachary Andrew Reed, Dayton, OH (US)

(21) Appl. No.: 18/968,022

(22) Filed: Dec. 4, 2024

(51) Int. Cl. F16L 55/164; B05B 7/24; B05B 12/00; B05B 15/40

(52) U.S. Cl. CPC F16L 55/164; B05B 7/2489; B05B 12/006; B05B 15/40

(57) ABSTRACT

A sealant injection unit for a duct sealing system includes a reservoir configured to store sealant, and a nozzle fluidly coupled to the reservoir and configured to inject the sealant inside an airstream injected inside a duct. Further, the sealant injection unit includes a pump configured to pump the sealant to the nozzle at a desired pressure, and a filter arranged upstream of the nozzle and configured to filter the sealant being delivered to the nozzle received from the pump.

### TECHNICAL FIELD

The disclosed subject matter relates generally to a duct sealing system for injecting sealant as aerosol inside a duct to seal any leakage. More particularly, the disclosed subject matter relates to a sealant injection unit for the duct sealing system for injecting/spraying the sealant inside the duct.

### BACKGROUND

Duct sealing systems force an incompressible fluid, for example, a sealant, through a small orifice of a nozzle to produce fine particles that are distributed inside a duct mixed with pressurized air. A major challenge to this process is that the sealant is susceptible to contamination, curing, and drying during operation and storage.

### SUMMARY

In accordance with one embodiment of the present disclosure, a sealant injection unit for a duct sealing system is disclosed. The sealant injection unit includes a reservoir configured to store sealant, and a nozzle fluidly coupled to the reservoir and configured to inject the sealant inside an airstream injected inside a duct. Further, the sealant injection unit includes a pump configured to pump the sealant to the nozzle at a desired pressure, and a filter arranged upstream of the nozzle and configured to filter the sealant being delivered to the nozzle received from the pump.

In some additional, alternative, or selectively cumulative embodiments, the sealant injection unit further includes a pressure sensor configured to determine a pressure of the sealant at a location downstream of the pump.

In some additional, alternative, or selectively cumulative embodiments, the sealant injection unit further includes a switch communicatively coupled to the pressure sensor and configured to control the pump based on input received from the pressure sensor.

In some additional, alternative, or selectively cumulative embodiments, the switch is a pressure switch and configured to control the pump based on the pressure of sealant determined by the pressure sensor.

In some additional, alternative, or selectively cumulative embodiments, the sealant injection the pressure switch stops the pump in response to the pressure detected by the pressure sensor being above a predefined threshold value.

In some additional, alternative, or selectively cumulative embodiments, the sealant injection unit includes a three way valve arranged between the pump and the filter and configured to selectively control the flow of sealant from the pump to the nozzle and the reservoir.

In some additional, alternative, or selectively cumulative embodiments, the three way valve fluidly connects the pump to the reservoir and disconnects the pump from the nozzle to bleed and direct the sealant and air from the pump to the reservoir to stop the injection of the sealant from the nozzle.

In some additional, alternative, or selectively cumulative embodiments, the three way valve fluidly connects the pump to the reservoir and disconnects the pump from the nozzle to prime the pump and remove air before initiating the injection of the sealant from the nozzle.

In some additional, alternative, or selectively cumulative embodiments, the three way valve disconnects the pump from the reservoir and connects the pump to the nozzle to allow the injection of the sealant from the nozzle.

In accordance with another embodiment of the present disclosure, a duct sealing system for injecting an aerosol inside a duct for sealing any leakage is provided. The duct sealing system includes an air induction unit configured to introduce pressurized air inside the duct, and a sealant injection unit configured to inject and mix sealant in the pressurize air and inside the duct. The sealant injection unit includes a reservoir configured to store sealant, and a nozzle fluidly coupled to the reservoir and configured to inject the sealant inside the pressurized air supplied inside the duct. Further, the sealant injection unit includes a pump configured to pump the sealant to the nozzle at a desired pressure, and a filter arranged upstream of the nozzle and configured to filter the sealant being delivered to the nozzle received from the pump.

In some additional, alternative, or selectively cumulative embodiments, the sealant injection unit comprises a pressure sensor configured to determine a pressure of the sealant at a location downstream of the pump.

In some additional, alternative, or selectively cumulative embodiments, the sealant injection unit further includes a switch communicatively coupled to the pressure sensor and configured to control the pump based on input received from the pressure sensor.

In some additional, alternative, or selectively cumulative embodiments, the switch is a pressure switch and configured to control the pump based on the pressure of sealant determined by the pressure sensor.

In some additional, alternative, or selectively cumulative embodiments, wherein the pressure switch stops the pump in response to the pressure, detected by the pressure sensor, is above a predefined threshold value.

In some additional, alternative, or selectively cumulative embodiments, the sealant injection unit further comprises a three way valve arranged between the pump and the filter and configured to selectively control the flow of sealant from the pump to the nozzle and the reservoir.

In some additional, alternative, or selectively cumulative embodiments, the three way valve fluidly connects the pump to the reservoir and disconnects the pump from the nozzle to bleed and direct the sealant and air from the pump to the reservoir to stop the injection of the sealant from the nozzle.

In some additional, alternative, or selectively cumulative embodiments, the three way valve fluidly connects the pump to the reservoir and disconnects the pump from the nozzle to prime the pump and remove air before initiating the injection of the sealant from the nozzle.

In some additional, alternative, or selectively cumulative embodiments, the three way valve disconnects the pump from the reservoir and connects the pump to the nozzle to allow the injection of the sealant from the nozzle.

### BRIEF DESCRIPTION OF THE DRAWINGS

Certain embodiments of the present disclosure will be better understood from the following description taken in conjunction with the accompanying drawings in which:

FIG. 1 is a front perspective view of a duct sealing system, in accordance with one embodiment of the present disclosure;

FIG. 2 is side perspective view of the duct sealing system depicting a sealant injection unit arranged inside a housing, in accordance with one embodiment of the present disclosure; and

FIG. 3 depicts a circuit diagram of the sealant injection unit schematically depicting various components of the sealant injection unit, in accordance with one embodiment of the present disclosure.

List of Elements: 100 duct sealing system, 102 air induction unit, 104 sealant injection unit, 106 housing, 108 reservoir, 110 nozzle, 111 outlet, 112 pump, 114 piston pump, 116 switch, 118 pressure switch, 120 pressure sensor, 122 manifold, 130 valve, 132 3 way valve, 134 inlet, 136 first outlet, 138 second outlet, 140 filter.

### DETAILED DESCRIPTION OF EXEMPLARY EMBODIMENTS

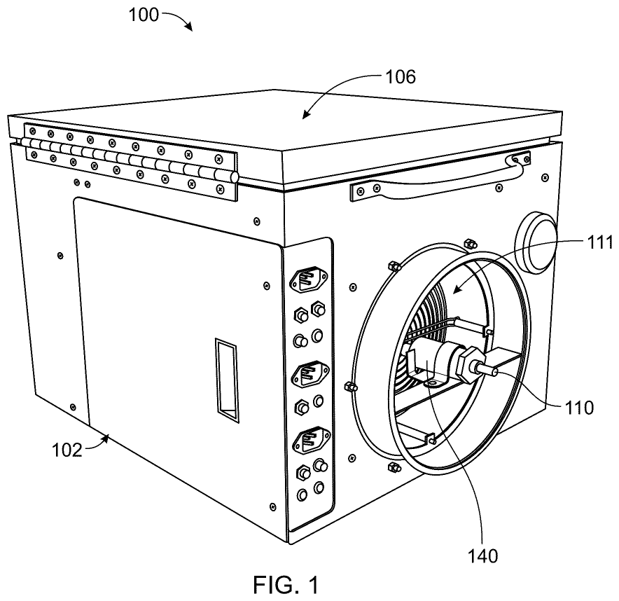

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-3, wherein like numbers indicate the same or corresponding elements throughout the views.

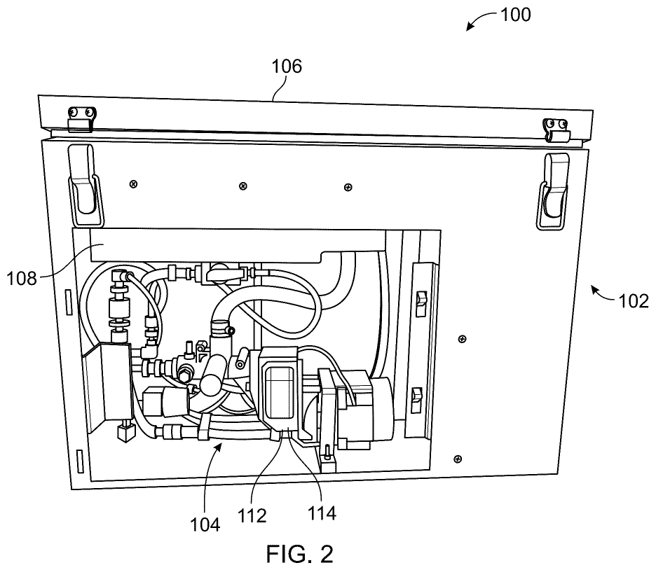

Referring to FIGS. 1 and 2, a duct sealing system, indicated generally at 100, is shown, in accordance with one embodiment of the present disclosure. The duct sealing system 100 includes an air induction unit 102 to pressurize air and induct pressurized air inside a duct and a sealant injection unit 104 to inject a sealant inside the duct to be mixed the pressurized air to form an aerosol that seals any leakage with the duct. The air induction unit 102 may include a fan (not shown) arranged inside a housing 106 and configured to draw air from an ambient and provide a pressurized air to the duct. It may be appreciated that the air induction unit 102 may include other suitable components that facilitates the supply of pressurized air to the duct for forming the aerosol with the sealant. Also, various components of the sealant injection unit 104 are supported on the housing 106.

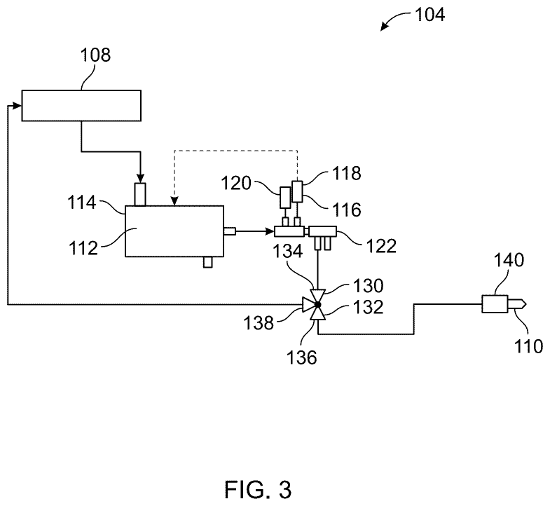

For injecting the sealant inside the duct, the sealant injection unit 104 includes a reservoir 108 to store the sealant and a nozzle 110, i.e., nozzle 110, to atomize and inject the sealant inside the duct and mix with the pressurized air. As shown in FIG. 2, the reservoir 108 is arranged inside the housing 106, while the nozzle 110, as shown in FIG. 1 is disposed outside the housing 106 at a location proximate to an outlet 111 of the housing 106 through which the pressurized air exit the housing 106. Moreover, referring to FIG. 3, the sealant injection unit 104 includes a pump 112 to supply the sealant from the reservoir 108 to the nozzle 110 at a desired pressure. In the embodiment, the pump 112 is a piston pump 114 that is operated to provide/pump the sealant at a desired pressure to the nozzle 110.

Continuing with FIG. 3, to control the pump 112, and hence to control pressure of the sealant provided by the pump 112, the sealant in injection unit 102 includes a switch 116 communicatively coupled to the pump 112 to control the pump 112. In an embodiment, the switch 116 is a pressure switch 118 that controls the pump 112 based on a pressure of the sealant at a location downstream of the pump 112. In an embodiment, the pump 112 is a single speed pump and configured to control the start and stop of the pump 112 based on the pressure of the sealant measured downstream of the pump 112 such that the pressure of the sealant being provided to the nozzle remains within a desired threshold limit i.e., a lower threshold value and an upper threshold value. Accordingly, the switch 116 is configured to stop the pump 112 when the pressure of the sealant downstream of the pump crosses the upper threshold value and restart the pump when the pressure of the sealant goes below the lower threshold value. In some embodiments, the pump 112 may be a variable speed pump configured to control the speed of the pump 112 to keep the pressure of the sealant with the desired threshold limit. In some embodiments, the sealant injection unit 104 also includes a manifold 122 arranged downstream of the pump 112, and sealant flows to the nozzle 110 from the pump via the manifold 122. The switch 116 and the pressure sensor 120 are mounted on the manifold 122, and the sensor is configured to measure the pressure of the sealant inside the manifold 122. However, the manifold 122 may be omitted.

To measure the pressure downstream of the pump 112, the sealant injection unit 104 includes at least one pressure sensor 120 and arranged in communication with the pressure switch 118. The pressure switch 118 based on the input received from the at least one pressure sensor 120 determines the pressure of the sealant downstream of the pump 112, and control the pump 112 to keep the pressure of the sealant, downstream of the pump, with the desired threshold limit. Although the pressure switch 118 is contemplated to control the pump 112, it may be appreciated that the switch 116 may be an electronic control switch and a controller may control the switch 112 to control the pump 112 based on the input received from the at least one pressure sensor 120.

Further, to control the flow of the sealant to nozzle 110, the sealant injection unit 104 includes a valve 130 arranged between the pump 112 and the nozzle 110 and fluidly connecting the nozzle 110 to the pump 112 and configured to control the flow of sealant to the nozzle 110 from the pump 112. In an embodiment, the valve 130 may be a start-stop valve that either stops the flow of the sealant to the nozzle 110 or allows the flow of the sealant to the nozzle 110. It may be appreciated that the flow rate of the sealant to the nozzle 110 may be controlled by controlling the pump 112. In some embodiments, the valve 130 may be metering valve that allows a control of the flow rate of sealant to the nozzle 110 from the pump 112.

In the illustrated embodiment, the 130 valve is a 3 way valve 132 having one inlet 134 connected to the pump 112 to receive the sealant from the pump 112 and two outlets, for example, a first outlet 136 connected to the nozzle 110, providing sealant to the nozzle 110 and a second outlet 138 connected to the reservoir 110 providing the sealant back to the reservoir 108 from the pump 112. The 3 way valve 132 is configured to be moved to a first position and a second position. In the first position, the valve 132 fluidly connects the nozzle 110 to the pump 112 and disconnects the reservoir 108 from the pump 112, while in the second position, the valve 132 fluidly connects the reservoir 108 to the pump 112 and disconnects the nozzle 110 from the pump 110. Accordingly, in the first position, the valve 132 enables the flow of the sealant from the pump 112 to the nozzle 110, while in the second position, the valve 132 stops the flow of sealant to the nozzle 110 and directs the flow of sealant from the pump 112 to the reservoir 108.

It may be appreciated that the valve 132 is moved to the second position to purge the air from the conduits and the pump 112 and prime the pump 112 by providing a low pressure path to sealant and air at a start of an injection event and before starting to inject the sealant inside the duct through the nozzle. The valve 132 may be arranged at the second position for a predefined duration from the start of the pump 112, at the start of the injection event, to fluidly connect the pump 112 to the reservoir 108 to purge any air from the pump 112 and the conduits. In the embodiment, the valve 132 is operated and moved to the first position after elapse of the predefined duration from the start of the pump 112 to allow the flow of sealant to the nozzle 110 to inject the sealant inside the duct and be mixed with the pressurized air delivered by the air induction unit 102. In some embodiments, the valve 132 is displaced between the first position and the second position manually by an operator. In some embodiments, the sealant injection unit 104 may include a controller that determines a starting of the injection event i.e., starting of the pump 112 to initiate the injection event, and upon such determination, the controller may position the valve 132 at the second position to fluidly connect the pump 112 to the reservoir 108 to remove any trapped air inside conduits and pump 112, and therefore prime the pump 112. In some embodiments, the controller displaces/moves the valve 132 to the first position upon elapse of the predefined duration from the start of the injection event to allow flow of the sealant from the pump 112 to the nozzle 110 to facilitate the injection of the sealant inside the duct from the nozzle 110.

Further, in some embodiments, to bleed and direct the sealant and air from the pump 112 to the reservoir 108 upon injection of the desired amount of sealant inside the duct, i.e., at the end of the injection event and therefore to stop the injection of the sealant from the nozzle 110, the valve 132 is moved to the second position from the first position, thereby disconnecting the nozzle 110 from the pump 112 and connecting the reservoir 108 to the pump 112. The pump 112 may be kept running for a predetermined duration after moving the valve to the second position from the first position to bleed any air and the sealant present inside the conduits. It may be appreciated that the pump 112 is thereafter stopped, while keeping the valve 132 at the second position to allow flow of any leftover sealant to the reservoir 108. In some embodiments, the valve 132 is moved to the second position from the first position for bleeding and removal of the air and sealant manually at the end of the injection event. In some embodiments, the controller may move the valve 132 to the second position from the first position either based on an input received from an operator or determination of the discharge of the desired sealant amount from the nozzle 110. Although the valve 130, 132 is shown and contemplated, it may be appreciated that valve 130, 132 may be omitted, and the flow to the nozzle 110 may be controlled by controlling the pump 112.

Furthermore, the sealant injection unit 104 includes a filter 140 arranged upstream of the nozzle 110 and downstream of the pump 112 to remove debris from the sealant provided to the nozzle 110 and thereby to prevent any clogging of the nozzle 110. In the embodiment, the filter 140 is disposed downstream of the valve 132, and includes a mesh size between 100 microns and 15 microns. In some embodiments, the mesh size of the filter 140 is between 35 microns and 15 microns. In some embodiments, the mesh size of the filter 140 is 25 microns. In some embodiments, the nozzle mounted to and is connected to an outlet of a filter housing that houses the filter 142, and the valve 132 is mounted to the filter housing and connected to an inlet of the filter housing.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A sealant injection unit for a duct sealing system, the sealant injection unit comprising:
a reservoir configured to store sealant;
a nozzle fluidly coupled to the reservoir and configured to inject the sealant inside an airstream injected inside a duct;
a pump configured to pump the sealant to the nozzle at a desired pressure; and
a filter arranged upstream of the nozzle and configured to filter the sealant being delivered to the nozzle received from the pump.

2. The sealant injection unit of claim 1 further comprises a pressure sensor configured to determine a pressure of the sealant at a location downstream of the pump.

3. The sealant injection unit of claim 2 further including a switch communicatively coupled to the pressure sensor and configured to control the pump based on input received from the pressure sensor.

4. The sealant injection unit of claim 3, wherein the switch is a pressure switch and configured to control the pump based on the pressure of sealant determined by the pressure sensor.

5. The sealant injection unit of claim 4, wherein the pressure switch stops the pump in response to the pressure detected by the pressure sensor being above a predefined threshold value.

6. The sealant injection unit of claim 1 further comprises a three way valve arranged between the pump and the filter and configured to selectively control the flow of sealant from the pump to the nozzle and the reservoir.

7. The sealant injection unit of claim 6, wherein the three way valve fluidly connects the pump to the reservoir and disconnects the pump from the nozzle to bleed and direct the sealant and air from the pump to the reservoir to stop the injection of the sealant from the nozzle.

8. The sealant injection unit of claim 6, wherein the three way valve fluidly connects the pump to the reservoir and disconnects the pump from the nozzle to prime the pump and remove air before initiating the injection of the sealant from the nozzle.

9. The sealant injection unit of claim 6, wherein the three way valve disconnects the pump from the reservoir and connects the pump to the nozzle to allow the injection of the sealant from the nozzle.

10. A duct sealing system for injecting an aerosol inside a duct for sealing any leakage, the duct sealing system comprising:
an air induction unit configured to introduce pressurized air inside the duct; and
a sealant injection unit configured to inject and mix sealant in the pressurize air and inside the duct, the sealant injection unit comprises
a reservoir configured to store sealant,
a nozzle fluidly coupled to the reservoir and configured to inject the sealant inside the pressurized air supplied inside the duct,
a pump configured to pump the sealant to the nozzle at a desired pressure, and
a filter arranged upstream of the nozzle and configured to filter the sealant being delivered to the nozzle received from the pump.

11. The duct sealing system of claim 10, wherein the sealant injection unit comprises a pressure sensor configured to determine a pressure of the sealant at a location downstream of the pump.

12. The duct sealing system of claim 11, wherein the sealant injection unit further includes a switch communicatively coupled to the pressure sensor and configured to control the pump based on input received from the pressure sensor.

13. The duct sealing system of claim 12, wherein the switch is a pressure switch and configured to control the starting and stopping of the pump based on the pressure of sealant determined by the pressure sensor.

14. The duct sealing system of claim 13, wherein the pressure switch stops the pump in response to the pressure, detected by the pressure sensor, is above a predefined threshold value.

15. The duct sealing system of claim 10, wherein the sealant injection unit further comprises a three way valve arranged between the pump and the filter and configured to selectively control the flow of sealant from the pump to the nozzle and the reservoir.

16. The duct sealing system of claim 15, wherein the three way valve fluidly connects the pump to the reservoir and disconnects the pump from the nozzle to bleed and direct the sealant and air from the pump to the reservoir to stop the injection of the sealant from the nozzle.

17. The duct sealing system of claim 15, wherein the three way valve fluidly connects the pump to the reservoir and disconnects the pump from the nozzle to prime the pump and remove air before initiating the injection of the sealant from the nozzle.

18. The duct sealing system of claim 15, wherein the three way valve disconnects the pump from the reservoir and connects the pump to the nozzle to allow the injection of the sealant from the nozzle.
